(19) United States
(12) Patent Application Publication
(10) Pub. No.: US 2026/0355824 A1
(43) Pub. Date: Nov. 12, 2026

(54) Method And Device For Producing Hybrid Structures Not Requiring Finishing

(71) Applicants: Premium Aerotec GmbH, Augsburg (DE); Fraunhofer-Gesellschaft zur Förderung der angewandten Forschung e.V., München (DE)

(72) Inventors: Lucas Kiefer, Augsburg (DE); Georg Schlick, München (DE); Ismail Ünsal, München (DE)

(73) Assignees: Premium Aerotec GmbH, Augsburg (DE); Fraunhofer-Gesellschaft zur Förderung der angewandten Forschung e.V., München (DE)

(21) Appl. No.: 19/137,954

(22) PCT Filed: Dec. 12, 2023
(86) PCT No.: PCT/EP2023/085357

§ 371 Date: Jun. 11, 2025

(30) Foreign Application Priority Data
Dec. 12, 2022 (DE) 10 2022 133 038.9

(51) Int. Cl. B22F 10/30; B33Y 10/00; B33Y 30/00; B33Y 50/02

(52) U.S. Cl. CPC B22F 10/30; B33Y 10/00; B33Y 30/00; B33Y 50/02

(57) ABSTRACT

A device for manufacturing hybrid structures is provided. The device comprises a cold gas spray head, a processing module, and a controller. The cold gas spray head and the processing module are arranged in a common unit. The controller is configured to control the operation of the cold gas spray head and the processing module such that a first operation is performed by the cold gas spray head and a second operation is performed by the processing module, wherein the first operation and the second operation are initiated sequentially or simultaneously. Furthermore, a method for manufacturing a hybrid structure using the device is provided.

### TECHNICAL FIELD

The present disclosure relates to a device for manufacturing a hybrid structure and to a corresponding manufacturing method.

### TECHNICAL BACKGROUND

Cold-gas spraying is a modern method in the field of thermal spraying. Compared to conventional methods, cold-gas spraying offers particular advantages, since the sprayed material is neither melted on nor melted onto during the process. The thermal influence on the layer and carrier material is thus minimized. During cold-gas spraying, a carrier gas (for example nitrogen) is heated under pressure, as a result of which a higher gas velocity is made possible. Particles of a material to be applied are then supplied and accelerated by the gas, as a result of which a high kinetic energy of the particles is achieved. The particles accelerated in this way are guided through a cooled convergent-divergent nozzle (DeLaval nozzle). After the particles impinge on the surface, they deform plastically and bond to the substrate to form a (high-)strength bond with the substrate. According to the current state of science, melting of the particles does not take place.

In additive methods, various pre-or post-processing steps are often necessary, such as, for example, prior grinding of a surface on which the material is to be sprayed, or subsequent sealing or irradiation of the sprayed-on material. In conventional additive methods (which do not use cold-gas spraying), combining the additive process with such pre-and post-processing processes is not possible or only possible to a limited extent on account of the thermal input of the additive method (for example by conventional spraying methods in which the sprayed material is heated/melted or by build-up welding). The emissions (e.g. laser radiation) of previous methods therefore allow a combination in the same end effector only to a very limited extent if at all.

### DESCRIPTION

Accordingly, it is an objective of the invention to provide a modular device and a method with shortened process time, integrated referencing and improved additive construction.

This objective is achieved by the subject matter of the independent claims. Further embodiments result from the dependent claims as well as from the following description.

According to a first aspect, a device for manufacturing hybrid structures is provided. The device comprises a cold gas spray head, a processing module, and a controller. The cold gas spray head and the processing module are arranged in a common unit. The controller is configured to control the operation of the cold gas spray head and the processing module such that a first operation is performed by the cold gas spray head and a second operation is performed by the processing module, wherein the first operation and the second operation are initiated sequentially or simultaneously.

Hybrid structures can be understood to be structures that are constructed from different composite materials, e.g., in the form of different material layers. For example, these can be printed circuit boards with applied conductor tracks, a battery arrangement with a battery layer with a thin metal layer and an insulator thereabove, or any other similarly constructed structure. The different layers do not necessarily have to be congruent. However, the above list is only exemplary.

Such hybrid structures can be manufactured, for example, by spraying a layer (or a partial layer) onto a base material/carrier material. The end product is manufactured in an additive method. In order to keep the thermal influence of the spraying process on the carrier material low, cold-gas spraying methods are particularly advantageous because of the avoidance of the melting on or melting onto of the sprayed material. However, in various applications, pre-processing of the carrier material (or of a previously applied layer before a further layer is applied) or post-processing of the applied layers is necessary. For example, it may be necessary to prepare a surface by milling, grinding, honing or other methods before a material layer is sprayed on, for example in order to improve the surface quality or in order to allow adaptation to a final dimension. Furthermore, it may be necessary to post-process an applied material layer, for example by applying a sealing.

The performance of such pre-and/or post-processing work steps with the spraying-on work step is not possible or only possible to a very limited extent together in a common unit in existing additive methods, such as, for example, in injection-molding methods in which the sprayed material is heated, because of the thermal input into the carrier material.

In the present case, it is proposed to combine cold-gas spraying methods, because of the absence or at least greatly reduced thermal input, with the performance of various and arbitrary pre-and/or post-processing steps, so that different work steps are performed successively or partially simultaneously by a single device, in that corresponding processing modules are arranged in a common unit. As a result, a significant reduction in the process time is achieved, since the workpiece for performing the pre- and/or post-processing processes does not have to be cycled out and moved into another device. In addition, as a result, automatic integrated referencing is provided, since the cold gas spray head and the corresponding processing module(s) are arranged in a fixed spatial relation to one another in the common unit. A precise successive performance of different work steps in one pass is thus made possible.

The fact that the first operation and the second operation are initiated sequentially or simultaneously means that these two operations are started at different (successive) times or both at the (at least substantially) same time. Thus, for example, the first operation can first be started and the second operation can be started after a certain period of time has elapsed. However, the first operation and the second operation can also be initiated at the same time. In addition, the second operation can also already be started, for example, while the first operation is still being performed or after the first operation has been ended. The cold gas spray head and the processing module are arranged, for example, so that the first operation and the second operation can be performed at least partially at the same time, but at different positions of the manufactured hybrid structure.

In this case, the common unit is defined by a common housing, in which the cold gas spray head and the processing module are arranged in direct spatial proximity to one another, so that the cold gas spray head and the processing module together follow a common path/path of movement by displacing or guiding the common unit.

The cold gas spray head comprises a heater in a housing between a gas supply and a cooled nozzle (e.g. a DeLaval nozzle). A highly compressed gas (e.g. nitrogen), which enters through the gas supply, is heated by the heater and thereby accelerated in the direction of the nozzle. A material powder can be introduced into the gas stream and is accelerated by the highly compressed gas. When the accelerated particles of the material powder emerge from the nozzle and impinge on a surface, the particles deform plastically and form the corresponding material layer on the carrier material.

The processing module can be any suitable module which carries out a corresponding working step in the manufacture of the hybrid structure, as described further below. If the processing module is intended to carry out a pre-processing step before spraying with the cold gas spray head, the processing module is arranged in front of the cold gas spray head with respect to the path of movement of the common unit, so that the movement module first sweeps over the carrier material and the corresponding working step is thus carried out on the carrier material (or on a previously applied layer on the carrier material) before the cold gas spraying. If the processing module is intended to carry out a post-processing step after spraying with the cold gas spray head, the processing module is arranged behind the cold gas spray head with respect to the path of movement of the common unit, so that the movement module sweeps over the carrier material after the cold gas spray head and the corresponding working step is carried out after the cold gas spraying.

Furthermore, it should be noted that, although only one processing module is described herein, an arbitrary number of processing modules can be present in the device in the common unit in a corresponding arrangement, in order to perform a plurality of work steps immediately successively or partially simultaneously.

The controller is configured to control all aspects of the operation of the cold gas spray head and the processing module or modules. In particular, the controller can also control the movement of the common unit over the carrier material. The controller can be, for example, a commercially available general-purpose computer with a CPU and corresponding memory components, an FPGA, an ASIC, or any other suitable control unit.

With regard to the first operation and the second operation, it should be recognized that no order of the operations is defined thereby. Rather, the order of the operations results from the intended manufacturing process or from the function of the processing module. Thus, the second operation can take place before the first operation if the processing module carries out a pre-processing, and the second operation can take place after the first operation if the processing module carries out a post-processing. Furthermore, it should be recognized that, in addition to the first operation and the second operation, further operations (e.g., a third operation, a fourth operation, etc.) can be present, in particular if more than one processing module is present, and the operations can be performed in any order corresponding to the intended manufacturing process.

According to one embodiment, the processing module is an applying module for performing an applying operation, or an ablating module for performing an ablating operation. Likewise, it can be a module for changing the material properties (for example UV exposure or local heat treatment).

An applying processing module can be, for example, a processing module that applies a sealing or another material layer. An ablating processing module is a processing module that ablates material from the carrier material or from a previously applied layer (for example by grinding or similar processes).

The processing module can furthermore also be a module that influences/changes, for example by energy input, the property of the material applied with the cold gas spray head, such as, for example, a laser, which can be useful in the implementation of laser sintering methods, or a heating module or the like. However, this list is merely exemplary and other processing modules are likewise conceivable.

According to a further embodiment, the processing module is one of a sealing module for applying a sealing, a laser module, a grinding module, a milling module, and a cutting module.

A sealing module or a laser module can serve, for example, as post-processing modules. Grinding, milling, or cutting modules can serve both as pre-processing module and as post-processing module.

According to a further embodiment, the processing module is a second cold gas spray head.

With such a second cold gas spray head, for example, immediately after the application of a first material, a second material layer can be applied over the first material layer. The material of the second material layer can be the same material as that of the first material layer or can be a different material.

Due to the provision of a second cold gas spray head, the first material layer does not first have to be applied completely, but a plurality of material layers can be applied substantially simultaneously. This is made possible in particular also by the fact that, during cold-gas spraying, the applied material does not first have to cure, as in the case of conventional spraying methods. As a result, the process time during the manufacture of multi-layered hybrid structures is shortened.

It should be noted that arbitrary further cold gas spray heads can be present in the common unit. Likewise, a plurality of cold gas spray heads can also be used together with one or more processing modules, depending on the intended manufacturing process, i.e. on the intended manufacturing steps during the manufacture of the hybrid structure.

According to a further embodiment, the device further comprises a suction, which is arranged in the common unit and which is configured to suck out excess working material from at least one working step.

By means of such a suction, excess material can be removed from the manufactured structure before the next working step, in order to avoid impurities in the subsequent manufacturing steps. A plurality of suctions can also be provided, e.g. on individual, on some, or on each sub-module of the common unit, i.e. for example on each cold gas spray head and on each processing module. The corresponding suctions can also be designed in such a way that the sucked-out material is separated from the individual sub-modules in order to be reused.

According to a further embodiment, the processing module is modularly exchangeable and comprises an identifier tag for identifying a type of the processing module by the controller.

For example, each processing module (and also each cold gas spray head) can comprise a corresponding interface for mechanically coupling further processing modules and/or cold gas spray heads to the processing module and for electronically coupling the further processing modules and/or cold gas spray heads to the controller, such that the controller can also control the operation of the coupled processing modules and/or cold gas spray heads. As a result, a flexible modular system is created which can be easily adapted to other requirements/manufacturing methods. A manufacturing method is understood to mean the performance of certain manufacturing steps by certain sub-modules and their time sequence. Different processing modules for different functions are, for example, structurally identical (with respect to shape, size, shape, mechanical and electrical specification, etc.) in order to be selectively introduced into the same slot or the same interface of the device.

The cold gas spray head and the further processing module can likewise be structurally identical, as described above, so that these two can exchange their position in the device. During a movement of the device in a certain direction, it can thus be made possible for the cold gas spray head to be arranged selectively in front of or behind the processing module in the direction of movement.

The identifier tag can be, for example, an RFID tag which can be read by the controller (for example by a corresponding reader attached to the common unit) and provides an identification of the corresponding processing module and its type. The controller can thus determine which sub-module is attached at which point.

According to a further embodiment, the controller is configured to perform a manufacturing process depending on the type of the processing module.

When a certain configuration of sub-modules is recognized, a corresponding manufacturing process can thus be performed without manual inputs being necessary. Corresponding manufacturing processes can be stored, for example, for different configurations of sub-modules in the memory of the controller, for example in a lookup table, and can be called up and performed by the controller when the corresponding configuration is recognized.

According to a further embodiment, the device further comprises a monitoring module for monitoring the quality of the manufactured hybrid structure.

The monitoring module can be any suitable module for monitoring the quality of the manufactured structure. For example, this can be a module that monitors a layer thickness of the applied material, for example by corresponding probes or sensors. A further possibility is, for example, a camera module or any other suitable module. The monitoring module, just like the cold gas spray head or the cold gas spray heads and the processing module(s), can be a modular module which can be attached to the device. Different monitoring modules can also be used.

Furthermore, the monitoring module or one of the monitoring modules can comprise a constant monitoring of the contact to the base structure and of the exit quantities, such that the monitoring module can also be integrated in one of the other sub-modules (cold gas spray heads/processing modules) or, for example, also in the controller.

According to a further embodiment, the device further comprises a robot arm, wherein the common unit is an end effector of the robot arm.

The device can in this case comprise a robot arm or also itself be the robot arm and the common unit is the end effector on the robot arm, to which different tools (in the form of the cold gas spray nozzles and the processing modules) can be attached. The robot arm then travels the corresponding path over the carrier material during the manufacture and carries out the corresponding manufacturing steps. The controller can be part of the robot arm itself or can be attached externally in a larger device or a larger manufacturing system which comprises the robot arm.

According to a second aspect, a method for manufacturing a hybrid structure using a device described above is provided. The method comprises, in a first step, loading a processing program into the device. In a second step, the method comprises positioning the common unit in an initial position. In a third step, the method comprises applying a first layer to a carrier material with the cold gas spray head. In a fourth step, the method comprises pre-processing, before the start of the third step, a component on which the hybrid structure is formed, or applying a second layer or post-processing the first layer, after the completion of the third step, with the processing module.

The device can be designed according to any of the embodiments described above.

The processing program comprises the manufacturing process or the steps of the manufacturing process and can be loaded, for example (in the first step), in corresponding embodiments, automatically from a memory of the controller when corresponding identifier tags are recognized, as described further above. However, in other embodiments, the processing program can also be loaded manually by an operator or automatically by a manufacturing system which comprises the device.

In the second step, the common unit, which comprises at least one cold gas spray head and a processing module, is brought into an initial position over the carrier material, for example over a circuit board on which conductor tracks are to be applied.

The application of the first layer to the carrier material (for example the circuit board) with the cold gas spray head then begins in the third step. The cold gas spray head can, for example, apply an electrically conductive material in the form of conductor tracks to the carrier material. For this purpose, the common unit is guided along a predefined path over the carrier material. However, it is also possible to apply closed layers over the entire area by the common unit, for example, spraying on paths lying next to one another one after the other.

The fourth step, although referred to here as the fourth step, does not necessarily take place after the third step. Rather, the fourth step is performed substantially simultaneously, or immediately before or immediately after the third step, and relates to an operation with the processing module. The terms “immediately before” or “immediately after” are always to be seen in terms of time with respect to a certain point on the carrier material or with respect to the processing of this point with the corresponding module. The cold gas spray head or the cold gas spray heads and the processing module(s) are operated at least temporarily simultaneously, but sweep over a certain point on the carrier material one after the other, such that the sub-module lying further forward with respect to the predefined path processes a corresponding point on the carrier material in front of a sub-module lying further rearward with respect to the path. If the processing module carries out a pre-processing step, the processing module is generally attached in front of the cold gas spray head in the common unit with respect to the predefined path and can thus first process every point on the predefined path (during simultaneous operation with the cold gas spray head). If the processing module carries out a post-processing step, the processing module is generally attached behind the cold gas spray head in the common unit with respect to the predefined path and thus processes every point on the predefined path (during simultaneous operation with the cold gas spray head) after the cold gas spray head.

If, for example, two processing modules, one for pre-processing and one for post-processing, are present in the device, the pre-processing module, the cold gas spray head, and the post-processing module can be arranged in a line in the common unit. The pre-processing module can be, for example, a grinding unit for prior smoothing of the carrier unit. The cold gas spray head then applies a desired material and the post-processing module can apply, for example, an electrically insulating sealing. However, this is merely an example and other modules and sequences are likewise possible.

In summary, by means of the invention, a device and a method for manufacturing hybrid structures are provided which enable a rapid simultaneous performance of multiple process steps on a carrier material at the same time. In particular, this is made possible by the absence or at least greatly attenuated thermal input into the carrier material by the use of a cold-gas spray nozzle. In addition, the device and the method can be easily adapted to changing requirements in a modular manner and enable a significant shortening of the process times, since the carrier material after the application of a first layer does not have to be cycled out and moved into another device for the subsequent steps.

### BRIEF DESCRIPTION OF THE FIGURES

Exemplary embodiments will be discussed in more detail below with reference to the attached drawings. The illustrations are schematic and not true to scale. Identical reference signs refer to identical or similar elements. The drawings show:

FIG. 1 A schematic illustration of a cold gas spray head.

FIG. 2 A schematic illustration of a device for manufacturing hybrid structures in a configuration as a robot arm with an end effector as a common unit.

FIG. 3 A flow chart of a method for manufacturing a hybrid structure.

### DETAILED DESCRIPTION OF EMBODIMENTS

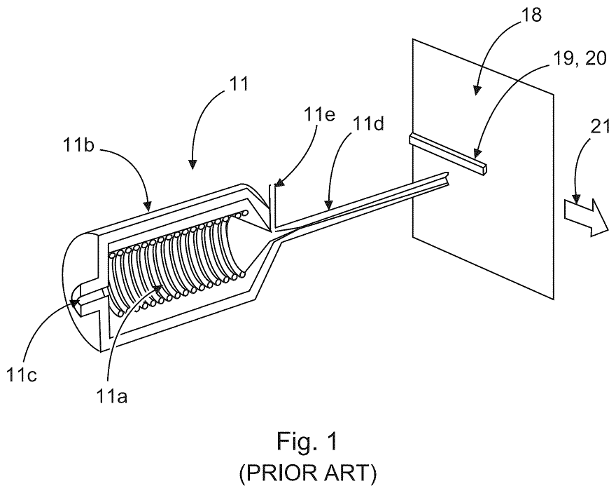

FIG. 1 shows a schematic illustration of a cold gas spray head 11 according to the prior art. The cold gas spray head 11 comprises a heater 11a (here in the form of a heating coil) in a housing 11b between a gas supply 11c and a cooled nozzle 11d (e.g. a DeLaval nozzle). A highly compressed gas (e.g. nitrogen), which enters through the gas supply 11c, is heated by the heater 11a and thereby accelerated in the direction of the nozzle 11d. A material powder can be introduced into the nozzle 11d via a powder supply 11e and is accelerated by the highly compressed gas. When the accelerated particles of the material powder emerge from the nozzle 11d and impinge on a surface of a carrier material 18, the particles deform plastically and form a corresponding first layer 20 (applied material 19) on the carrier material 18. The cold gas spray head is guided laterally over the carrier material 18 along a path 21 of movement. If a closed first layer is to be formed, the cold gas spray head can apply parallel paths of applied material 19 in the same way. The applied material 19 can, for example, be an electrically conductive material and the carrier material 18 can, for example, be a circuit board on which conductor tracks are to be applied.

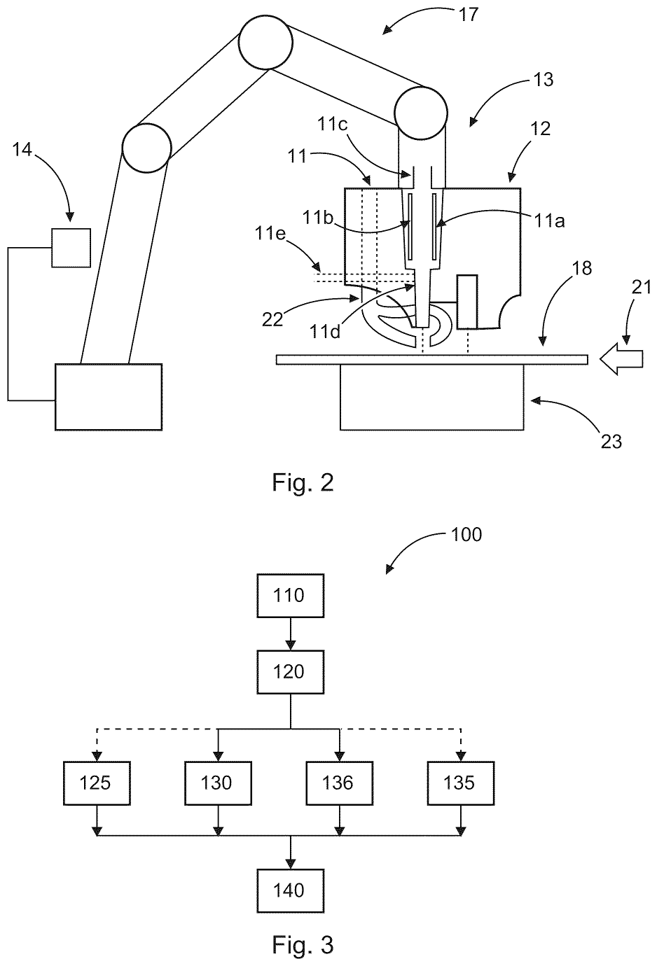

FIG. 2 shows a schematic illustration of a device 10 for manufacturing hybrid structures according to the disclosure. The device 10 is embodied here as a robot arm 17 and has a common unit 13 or an end effector 13 with a cold gas spray head 11 and a processing module 12. A controller 14, such as, for example, a general-purpose computer with a CPU and memory components, is functionally connected to the robot arm 17 and controls the operation thereof and thus also the operation of the end effector 13 or the cold gas spray head 11 and the processing module 12.

The cold gas spray head 11 and the processing module 12 together form the end effector 13 (i.e. the common unit 13, as described further above). The cold gas spray head 11 has a heater 11a, a housing 11b, a gas supply 11c, a cooled nozzle 11d and a powder supply 11e, as described above with reference to FIG. 1. A suction 22 is attached around the outlet region of the nozzle 11d in order to suck out excess material.

The processing module 12 is designed in the illustrated configuration as a post-processing module, in particular as a sealing unit for applying a sealing. In other embodiments, the processing module 12 can, however, also be, for example, a pre-processing module (for example a grinding unit, a milling unit, a cutting unit), or a laser module (both for pre-processing the carrier material and for post-processing the applied material, for example in laser sintering methods or similar methods). Furthermore, as described further above, further processing modules 12 or further cold gas spray heads 11 can also be part of the end effector 13, in order to further perform pre-processing or post-processing steps or to apply further layers, for example of other materials. The processing module can carry out both applying and ablating operations. For example, the processing module can also grind a previously applied layer smoothly before a next layer is applied.

A carrier material 18, for example a circuit board, is held on a holding structure 23. The robot arm 17 operates the end effector 13 and guides it over the carrier material 18 along the path 21 of movement, wherein the cold gas spray head 11 and the processing module 12 are operated simultaneously. The cold gas spray head 11 can thereby apply, for example, a metallic, electrically conductive material in the form of conductor tracks to the carrier material 18, which is sprayed over directly thereon in a pass by the processing module 12 with a sealing. However, this is only one example. In other configurations, the device 10 can also be used for other applications, e.g. for constructing a layered structure such as a sandwich structure or for forming battery layers with a thin metal layer with an insulator layer thereabove. Furthermore, the device can be configured for an AFP (Automated Fiber Placement) method in order to manufacture two layers simultaneously. However, these are only some non-limiting examples. If a closed material layer is to be applied, the end effector 13 can also be guided over the carrier material 18, for example, in parallel paths.

FIG. 3 shows a flow chart of an exemplary method 100 for manufacturing a hybrid structure using a device 10 disclosed herein, for example the device 10 of FIG. 2. In a first step 110, a processing program is loaded into the device 10. This can take place, for example, by manual user input into the controller 14 or automatically, for example by recognizing a configuration of the common unit 13 by the controller 14, for example on the basis of RFID tags, as described further above.

In step 120, the common unit 13, which comprises at least one cold gas spray head 11 and at least one processing module 12, is brought into an initial position over the carrier material.

The steps 125, 130, 136 and 135 can take place substantially simultaneously, since they take place, as described above, in one pass by the movement of the common unit 13 with corresponding equipment on cold gas spray heads 11 and processing modules 12 along the path 21 of movement. In step 125, the carrier material 18, or, if a different layer has previously been applied, to which a further layer, the previous layer, is now applied, is pre-processed. The pre-processing 125 can consist, for example, of grinding by a corresponding processing module. At the same time, a first layer is applied in step 130, or a second layer is applied in step 135 (if a first layer has already been applied previously, for example by a different cold gas spray head 11 in the common unit 13), and the first layer is post-processed in step 136. The post-processing can take place, for example, in the application of a sealing or in a change in the material properties of the material applied by the cold gas spray head 11, for example by a heating or laser unit or any other suitable unit.

Although the steps 125, 130, 136 and 135 are each carried out simultaneously in terms of time, they are each carried out at points on the carrier material 18 that are slightly offset with respect to one another. In this sense, the designation “simultaneously” does not refer to a simultaneous execution of the respective steps at an individual point on the carrier material, but rather to the simultaneous execution with respect to the overall component. The time sequence of the steps at every point on the path 21 of movement is slightly offset and is defined by the arrangement of the individual sub-modules 11, 12 in the common unit 13, as described above. The method ends at 140 and can be repeated if necessary. Optionally, a suction of residual material can take place simultaneously with the steps 125, 130, 136 and 135 by means of suctions 22 (FIG. 2) attached to the corresponding sub-modules.

In addition, it should be noted that “comprising” or “having” does not exclude any other elements or steps and “a” or “an” does not exclude a plurality. Furthermore, it should be noted that features or steps which have been described with reference to one of the above exemplary embodiments can also be used in combination with other features or steps of other exemplary embodiments described above. Reference signs in the claims are not to be regarded as a limitation.

### LIST OF REFERENCE SIGNS

10 Device for manufacturing hybrid structures
11 Cold gas spray head
11a Heater
11b Housing
11c Gas supply
11d Cooled nozzle, DeLaval nozzle
11e Powder supply
12 Processing module
13 Common unit, end effector
14 Controller
15 Identifier tag, RFID tag
16 Monitoring module
17 Robot arm
18 Carrier material
19 Applied material
20 First layer
21 Path of movement
22 Suction
23 Holding structure
30 Second layer
100 Method
110 Loading a processing program
120 Positioning the end effector in an initial position
125 Pre-processing a component
130 Applying a first layer
135 Applying a second layer
136 Post-processing the first layer
140 End of the method

1. An device for manufacturing hybrid structures, comprising:
a cold gas spray head;
a processing module; and
a controller;
wherein the cold gas spray head and the processing module are arranged in a common unit;
wherein the controller is configured to control the operation of the cold gas spray head and the processing module such that a first operation is performed by the cold gas spray head and a second operation is performed by the processing module, wherein the first operation and the second operation are initiated sequentially or simultaneously.

2. The device according to claim 1, wherein the processing module is an applying module for performing an applying operation, or an ablating module for performing an ablating operation.

3. The device according to claim 2, wherein the processing module is one of a sealing unit for applying a sealing, a laser unit, a grinding unit, a milling unit, and a cutting unit.

4. The device according to claim 1, wherein the processing module is a second cold gas spray head.

5. The device according to claim 1, further comprising a suction arranged in the common unit and configured to suck out excess working material from at least one working step.

6. The device according to claim 1, wherein the processing module is modularly exchangeable and comprises an identifier tag for identifying a type of the processing module by the controller.

7. The device according to claim 6, wherein the controller is configured to perform a manufacturing process depending on a type of the processing module.

8. The device according to claim 1, further comprising a monitoring module for monitoring a quality of a manufactured hybrid structure.

9. The device according to claim 1, further comprising a robot arm, wherein the common unit is an end effector of the robot arm.

10. A method for manufacturing a hybrid structure using a device according to claim 1, wherein the method comprises:
in a first step, loading a processing program into the device;
in a second step, positioning the common unit in an initial position;
in a third step, applying a first layer to a carrier material with the cold gas spray head; and
in a fourth step, pre-processing, before the start of the third step, the carrier material on which the hybrid structure is formed, or applying a second layer or post-processing the first layer, after the completion of the third step, with the processing module.
